(19) United States
(12) Patent Application Publication
(10) Pub. No.: US 2004/0071942 A1
(43) Pub. Date: Apr. 15, 2004

(54) Object made of glass or glass-ceramic material

(76) Inventor: Bernd Schultheis, Schwabenheim (DE)

Correspondence Address: Pauley Petersen Kinne & Erickson, Suite 365, 2800 W. Higgins Road, Hoffman Estates, IL, 60195, US

(21) Appl. No.: 10/462,103

(22) Filed: Jun. 13, 2003

(30) Foreign Application Priority Data
Jun. 14, 2002 (DE) 102 26 561.5

(51) Int. Cl. B32B 3/00

(52) U.S. Cl. 428/195.1; 428/210

(57) ABSTRACT

An object at least partially of a glass material or glass-ceramic material, having an imprint applied by non-digital printing techniques. This invention also relates to a method for decorating an object made of a glass material or a glass-ceramic material, wherein a printed image is applied to a surface area of the glass material or the glass-ceramic material by a non-digital printing technique. In order to obtain individually varying imprints on such objects, the glass material or the glass-ceramic material has at least one surface area with a printed image created by digital printing technology.

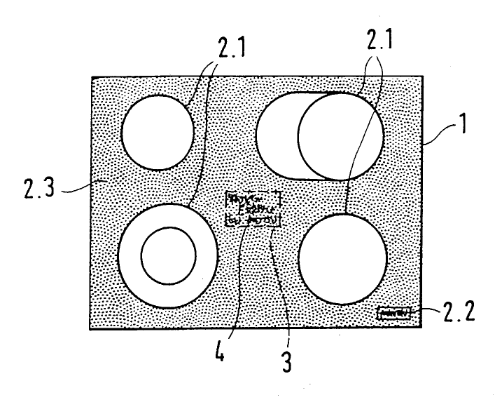

### BACKGROUND OF THE INVENTION

1. Field of the Invention

This invention relates to an object at least partially of glass or glass-ceramic material, having an imprint applied thereon by non-digital printing techniques.

2. Discussion of Related Art

Decorated glass-ceramic cooking surfaces are known, for example CERAN glass-ceramic cooking surfaces, stove panels and oven windows made of glass. Windshields, side and rear windows are known in the field of automobile glass, which have a printed covering, black as a rule, at the edges. Glass ampoules, or containers made of glass are known in the field of pharmaceutical packaging, on which the logo of the manufacturer, the name of the preparation and/or production batch identification markings are printed.

The decorations, or identification markings, of the above mentioned objects made of glass or glass-ceramic material are applied by screen printing. Screen printing is proven for imprinting glass in particular, and is economically used, particularly with large batches. It is also possible to produce relatively thick, and therefore opaque, layers on the glass objects in one printing step. However, one disadvantage is that individual decors and/or identification markings cannot be produced economically with this method.

There is also a desire for imprinting such objects economically with an individual decor or information, so that design and market trends can be followed, and to offer improved traceability within the scope of production logistics and manufacturers' liabilities, theft protection, as well as protection against imitators and forgers.

In connection with automobile windows, there is an option of applying the chassis number to every one of the windows with special etching paint in order to assure an improved theft protection, in particular in connection with expensive vehicles of the luxury class. This method is expensive and time-consuming and can result in damage to the vehicle if not handled properly.

Other methods have been proposed, where individual decors, or identification markings can be produced on glass, for example as discussed in European Patent Reference EP 0 647 885. For now, advantages of screen printing alone cannot be employed. Furthermore, such decal techniques are cumbersome in connection with modern production runs.

Printing devices which permit imprinting directly on the glass or the glass-ceramic material are more suitable, such as taught by German Patent Reference DE 198 49 500.

A method is known from European Patent Reference EP 0 647 885 A1, where a decal is produced by electro-photographic techniques and with the use of ceramic toners. However, the decal technique is not successful for modern production runs. Therefore methods have been developed which permit printing directly on the glass or the glass-ceramic material, such as is shown in German Patent Reference DE 198 49 500 A1.

### SUMMARY OF THE INVENTION

It is one object of this invention to provide an object of the type mentioned above but which has, in addition to already applied decorations or identification markings, also individually imprinted surface areas. It is also an object of this invention to provide a method for imprinting such an object.

The above objects of this invention are achieved with glass or the glass-ceramic material that has at least one surface area with a printed image produced by digital printing techniques, also known as a digital image.

With the combination of the two printing techniques, digital printing for one and non-digital printing, it is possible to combine the respective advantages of the individual methods. The digital image makes it possible to lend an individual character to the object, or to contain additional information only relating to this object, or its contents.

With this it is possible, for example, to assure traceability, which makes the object, or its contents, unique. The digital image can be changed piece by piece, for achieving the greatest possible flexibility. The non-digitally generated printed image can be applied in the conventional way, for example by screen printing. During this, methods which are developed to completion in large technological processes are employed, by which complex decors of good quality can be produced.

During this, the digital technology can be used for imprinting a bar code, a number code, a matrix code and/or a 2-D bar code on the object. These digital prints can be read out by scanners in individualized ways.

In accordance with one embodiment of this invention, the digital image, formed by a ceramic color, is preferably created by a ceramic toner. Then the ceramic paint can be permanently burned in, particularly into the surface of the glass or that of the glass-ceramic material. In one embodiment, the printed image is created at least partially by a color which is based on plastic, preferably by a toner with a thermoplastic or duromeric plastic matrix, is also conceivable.

One object relating to the method of this invention is to apply a digitally created printed image, a digital image for short, to a further surface area of the glass or the glass-ceramic material by digital printing technology.

The two printing processes can be performed simultaneously or in chronologically or spatially separate sequences. If the printing processes are sequential, they can be separated from each other by a print medium fixation. It is also possible for the non-digital printing to be performed at the factory. Individualization then only occurs at the end user by digital printing. New logistical possibilities are thus possible.

For fixation of the print, according to this invention the digital image and the non-digitally created printed image are simultaneously burned into the glass or the glass-ceramic material.

When applying the printing technique in connection with glass-ceramic materials in particular, it is possible for the digital image to be fixed by a locally limited burning process acting on the surface of the glass-ceramic material.

For achieving a dependable fixation when using ceramic colors, the burning of the ceramic colors, which create the digital image at least partially, can occur at a temperature ≧700° C. and during a burning time ≧3 minutes.

The creation of the digital image can occur in various ways in accordance with the method of this invention.

The digital image can be applied by electro-photographic or inkjet printing methods. It is also possible to apply the digital image by a laser method, wherein a printing medium is applied over a large portion of the glass or the glass-ceramic material, which is then burned in locally with a laser.

In accordance with another embodiment of this invention, the digital image is applied and burned into the glass or the glass-ceramic material, and subsequently the glass or the glass-ceramic material is thermally tempered.

In one embodiment of this invention, the digital image is created with the use of a plastic-based color, preferably with a toner with a thermoplastic or duromeric plastic matrix, and the digital image is fixed at a temperature in the range between 130° C. and 200° C.

### BRIEF DESCRIPTION OF THE DRAWING

This invention is explained in greater detail in view of different exemplary embodiments, wherein the single drawing figure shows a top view on a cooking surface made of a glass-ceramic material.

### DESCRIPTION OF PREFERRED EMBODIMENTS

### Exemplary Embodiment 1: Cooking Surfaces Made of Glass-Ceramic Material

A cooking surface 1 made of a glass-ceramic material is schematically shown in the drawing. The cooking zone markers 2.1, the manufacturers' logos 2.2, as well as the decorated areas 2.3, which have a defined decor grid and are produced in comparatively large batches by screen printing technology, are shown. In addition, the cooking surface 1 has at least one additional surface area 3, to which individual markings or logos are applied in the form of a digital image 4 created by digital technology.

For example, the digital images 4 are:

Characters, such as “Private Edition—Exclusive to <NAME of the end user, NAME of the electric appliance dealer, or NAME of the kitchen studio>”, “Edition . . . ”;

Company logos, for example those of large furniture stores, kitchen appliance stores or electric appliance stores, which sell the cooking surfaces 1;

Bar codes, number codes, matrix codes or 2-D bar codes, etc., used for showing the production batch, number of the article, or the like;

Screened-on images, for example of the end user (for example in connection with the character “Family Edition”+photographs of the family members, for example within each cooking zone);

Characters in Asiatic or Arabic languages containing safety notices, wherein the characters often have fine lines, which cannot be printed finely enough in the course of normal decorating; and/or

Fine symbols within functional zones, such as control fields inside of the cooking surfaces 1.

Digital printing technologies, such as inkjet methods or electro-photographic methods, are used for producing the individual digital images 4. However, laser methods, wherein the printing medium is initially applied over a large surface and is subsequently burned in by the laser, are basically also suitable for the production.

Because of the high processing speed and of the ceramic colors used in the process, electro-photographic methods, wherein the ceramic color in the form of ceramic toner is printed directly on the glass-ceramic material, are particularly advantageous.

Printing can occur immediately afterwards, following the customary screen printing, onto the cooking surface not yet ceramized, or off-line onto the decorated and already ceramized cooking surface. In the first case, burning in occurs together with the screen-printed, possibly intermediately dried decorator ceramic colors or, in the second case, by an additional short burn-in process, which in the case of glass-ceramic material, can only occur locally because of the zero expansion behavior. It is sufficient if only the surface area 3 with the digital images 4 is heated to a temperature of >700° C. (typically approximately 720° C.) for five to ten minutes. In principle, this also opens new logistic opportunities, which make possible the later individualization shortly prior to delivery to the end user.

### Exemplary Embodiment 2: Glass-Ceramic Fireplace Window

Because this is also a glass-ceramic material, the production process can be performed as in the Exemplary Embodiment 1. Similar possibilities also result for the digital images 4, as already described above.

### Exemplary Embodiment 3: Stove Windows and Control Panels for Household Appliances

Embodiments as in Exemplary Example 1 can basically be realized in accordance with this invention. When using ceramic colors, the second digital printing process occurs prior to the tempering process. Burn-in after tempering of the glass is no longer possible. If using colors based on plastic, for example duroplastic or thermoplastic colors, the fixation of the color is also possible after tempering (temperatures typically between 130 and 200° C., depending on the plastic material). However, with this application first the area of the individual characters is printed as a rule, and thereafter, following intermediate drying, the entire surface is background-printed by screen printing.

### Exemplary Embodiment 4: Automobile Glass

Front, side or rear windows of motor vehicles are involved in this exemplary embodiment, which have a decoration in the form of circumferential edges, mostly dyed black, which should have the best possible opacity for covering adhesive spots or mounting elements. This edge printing is usually performed in a first printing step by screen printing. These windows have zones in addition, to which individual characters and codes are applied containing the subsequent identification code of the vehicle, or contain sequential serial numbers which, following the assembly of the vehicle, result in an identification code for the vehicle together with the chassis number of the vehicle, which can be used for improved tracking in case of theft.

In addition, this code can also provide information regarding the production time, or other manufacturers' information, such as item number, vehicle type, etc., such as machine-readable bar codes, machine-readable matrix codes, numbers and/or letters, etc.

Here, too, the employment of ceramic colors provides one advantage that these are permanently burned into the glass surface during the subsequent tempering process.

The manufacturing process for such individualized automobile windows is also based on a two-stage printing process here, which combines screen printing with digital printing, in this case electro-photographic printing processes in particular.

### Exemplary Embodiment 5: Pharmaceutical Packaging

It is customary today, often prescribed by law, that ampoules or small glass vials must be provided with the name of the preparation and information regarding the production date and the batch. In addition to batch identification, the pharmaceutical packaging in accordance with this invention has zones which, for one, contain coded serial numbers used for tracing, and also logos or matrix codes which, because of their fine resolution, are used for protection against forgers and imitators.

For example, such logos are fine matrix codes in the shape of a pixel field, by which comparatively extensive individual information can be stored in the smallest space. They can then be read out by special scanners.

### Exemplary Embodiment 6: Door Signs and Directional Building Signs Made of Glass

Door signs made of glass are often used in modern office buildings. However, these are merely two panes of glass, between which a foil is inserted, on which the name, the room number, as well as further information is printed.

In accordance with this invention, one such door sign has a single pane, on which frames, company logos, or other, not individual characters, are printed (blank). The pane also contains areas in which individual room identifications, references, names and department identifications are printed.

### Exemplary Embodiment 7: Individually Imprinted Control Panels Made of Glass

Individually imprinted control panels made of glass for admission control, elevator controls, etc. Here, the individual identification for access areas, names, floor identification, etc. is characteristic.

### Exemplary Embodiment 8: Imprinted Milk Bottles for Babies

The milk bottles have a standard decor and can be individualized with a specific imprint. For example, the name, the weight, the birthdate, etc. can be applied by digital printing for individualization.

The digital image 4 can be imprinted prior to or after the generation of the imprint which is not applied by digital printing techniques.

German Patent Reference 102 26 561.5, the priority document corresponding to this invention, and its teachings are incorporated, by reference, into this specification.

What is claimed is:

1. An object at least partially of a glass material or a glass-ceramic material, having an imprint applied thereon by non-digital printing techniques, the object comprising:
the glass material or the glass-ceramic material having at least one surface area with a printed image produced by a digital printing technique.

2. The object in accordance with claim 1, wherein a digital image (4) produced by the digital printing technique contains at least one of a writing, a location, a screened-on image and a symbol.

3. The object in accordance with claim 2, wherein the digital image (4) contains at least one of a bar code, a number code, a matrix code and a 2-D bar code.

4. The object in accordance with claim 3, wherein the digital image (4) is formed from a ceramic color, and is created by a ceramic toner.

5. The object in accordance with claim 4, wherein the printed image is applied by one of an ink dabber printing process, an offset printing process and a screen printing process.

6. The object in accordance with claim 5, wherein the digital image (4) is burned into a surface of the glass material or the glass-ceramic material.

7. The object in accordance with claim 6, wherein the printed image (4) is created at least partially by a color which is based on plastic, preferably by a toner with one of a thermoplastic and a duromeric plastic matrix.

8. A method for decorating an object made of a glass or a glass-ceramic material, wherein a printed image is applied to a surface area of the glass material or glass-ceramic material by a non-digital printing technique, the method comprising:
applying a digitally created printed image to a further surface area of the glass material or the glass-ceramic material by a digital printing technique.

9. The method in accordance with claim 8, wherein a digital image (4) produced by the digital printing technique and a non-digitally created print image are printed in at least one of a chronologically sequence and a spatially separated sequence.

10. The method in accordance with claim 9, wherein the digital image (4) and the non-digitally created print image are simultaneous burned into the glass material or the glass-ceramic material.

11. The method in accordance with claim 9, wherein the digital image (4) is fixed by a burning process which acts on the glass-ceramic material surface in a locally limited manner.

12. The method in accordance with claim 11, wherein the burning of the ceramic colors, which create the digital image (4) at least partially occurs at a temperature≧700° C. and during a burning time≧3 minutes.

13. The method in accordance with claim 12, wherein the digital image (4) is applied by one of an electro-photographic method and an inkjet printing method, or the digital image (4) is applied by a laser method, wherein a printing medium is applied over a large portion of the glass material or the glass-ceramic material, which is then burned in locally by a laser.

14. The method in accordance with claim 13, wherein the digital image (4) is applied and burned into the glass material or the glass-ceramic material, and subsequently the glass material or the glass-ceramic material is thermally tempered.

15. The method in accordance with claim 13, wherein the digital image (4) is created with one of a plastic-based color and a toner with a thermoplastic matrix or duromeric plastic matrix, and the digital image (4) is fixed at a temperature in a range between 130° C. and 200° C.

16. The method in accordance with claim 10, wherein the burning of the ceramic colors, which create the digital image (4) at least partially occurs at a temperature≧700° C. and during a burning time≧3 minutes.

17. The method in accordance with claim 8, wherein a digital image (4) is applied by one of an electro-photographic method and an inkjet printing method, or the digital image (4) is applied by a laser method, wherein a printing medium is applied over a large portion of the glass material or the glass-ceramic material, which is then burned in locally by a laser.

18. The method in accordance with claim 8, wherein a digital image (4) is applied and burned into the glass material or the glass-ceramic material, and subsequently the glass material or the glass-ceramic material is thermally tempered.

19. The method in accordance with claim 8, wherein a digital image (4) is created with one of a plastic-based color and a toner with a thermoplastic matrix or duromeric plastic matrix, and the digital image (4) is fixed at a temperature in a range between 130° C. and 200° C.

20. The object in accordance with claim 1, wherein a digital image (4) produced by the digital printing technique contains at least one of a bar code, a number code, a matrix code and a 2-D bar code.

21. The object in accordance with claim 2, wherein a digital image (4) produced by the digital printing technique is formed from a ceramic color, and is created by a ceramic toner.

22. The object in accordance with claim 1, wherein a printed image is applied by one of an ink dabber printing process, an offset printing process and a screen printing process.

23. The object in accordance with claim 1, wherein a digital image (4) produced by the digital printing technique is burned into a surface of the glass material or the glass-ceramic material.

24. The object in accordance with claim 1, wherein a printed image (4) produced by the digital printing technique is created at least partially by a color which is based on plastic, preferably by a toner with one of a thermoplastic and a duromeric plastic matrix.
